(19) United States
(12) Patent Application Publication
(10) Pub. No.: US 2024/0168828 A1
(43) Pub. Date: May 23, 2024

(54) ADAPTIVELY OPTIMIZING FUNCTION CALL PERFORMANCE

(71) Applicant: Intel Corporation, Santa Clara, CA (US)

(72) Inventors: Joseph Grecco, Saddle Brook, NJ (US); Mukesh Gangadhar Bhavani Venkatesan, Bangalore (IN)

(73) Assignee: Intel Corporation, Santa Clara, CA (US)

(21) Appl. No.: 18/058,420

(22) Filed: Nov. 23, 2022

(51) Int. Cl. G06F 9/54

(52) U.S. Cl. CPC G06F 9/544

(57) ABSTRACT

Embodiments described herein are generally directed to improving performance of a transactional API protocol by adaptively optimizing function call performance at runtime. In an example, a command stream is monitored that includes function calls associated with the transactional API to be carried out by an executer on behalf of an application. An amount of data transmitted over an interconnect between the application and the executer is reduced by: (i) identifying a sequence of multiple of the function calls that represents a batch and satisfies a set of one or more criteria; (ii) creating a template of the batch having a symbolic name and including placeholders for a subset of variable arguments of the multiple of the function calls; and (ii) after observing a subsequent occurrence of the sequence within the command stream, transmitting via the interconnect the symbolic name and values for the subset of variable arguments.

### TECHNICAL FIELD

Embodiments described herein generally relate to the field of remote procedure call (RPC) technology and, more particularly, to adaptively optimizing performance of a transactional application programming interface (API) protocol to reduce an amount of data transmitted over an interconnect between an application and an executer by monitoring a command stream including function calls of the transactional API protocol, creating named batches for repeated sequences of function calls, and when the sequence is observed again, transmitting the named batch via the interconnect to cause the executer to carry out the sequence.

### BACKGROUND

RPC is a software communication protocol that one program (e.g., an application) running on a client (e.g., an application platform) can use to request a service from a remote compute resource (e.g., a central processing unit (CPU), a graphics processing unit (GPU), application-specific integrated circuit (ASIC), or a field-programmable gate array (FPGA)), which may be referred to herein as an executer.

A transactional API protocol generally represents an interface scheme that makes use of RPCs (which may be referred to herein as function calls) in which performance of an atomic unit of work involves invoking a prescribed sequence of function calls. A transactional API may be implemented in the form of various types of RPC platforms or frameworks, including representational state transfer (REST), gRPC, and graph query language (GraphQL).

### BRIEF DESCRIPTION OF THE DRAWINGS

Embodiments described here are illustrated by way of example, and not by way of limitation, in the figures of the accompanying drawings in which like reference numerals refer to similar elements.

FIG. 1A is a block diagram illustrating actors involved in a transactional API protocol.

FIG. 1B is a message sequence diagram illustrating delays incurred in connection with an exchange of messages of a transactional API protocol between an application and an executer.

FIG. 2A is a block diagram illustrating an operational environment supporting batch scheduling of function calls of a transactional API protocol according to some embodiments.

FIG. 2B is a message sequence diagram illustrating interactions among various actors involved in performing batch scheduling of multiple function calls of a transactional API protocol according to some embodiments.

FIG. 3 is a flow diagram illustrating operations for performing function call pre-processing according to some embodiments.

FIG. 4 is a flow diagram illustrating operations for performing request scheduling according to some embodiments.

FIG. 5 is a flow diagram illustrating operations for performing service scheduling according to some embodiments.

FIG. 6 is a block diagram illustrating an operational environment supporting creating and use of named batches for function calls of a transactional API protocol according to some embodiments.

FIG. 7 is a high-level flow diagram illustrating operations for creation and use of named batches according to some embodiments.

FIG. 8 is a flow diagram illustrating operations for performing command stream monitoring according to some embodiments.

FIG. 9 is a flow diagram illustrating operations for performing adaptive optimization processing according to some embodiments.

FIG. 10 is a flow diagram illustrating additional operations for performing service scheduling according to some embodiments.

FIG. 11 is an example of a computer system with which some embodiments may be utilized.

### DETAILED DESCRIPTION

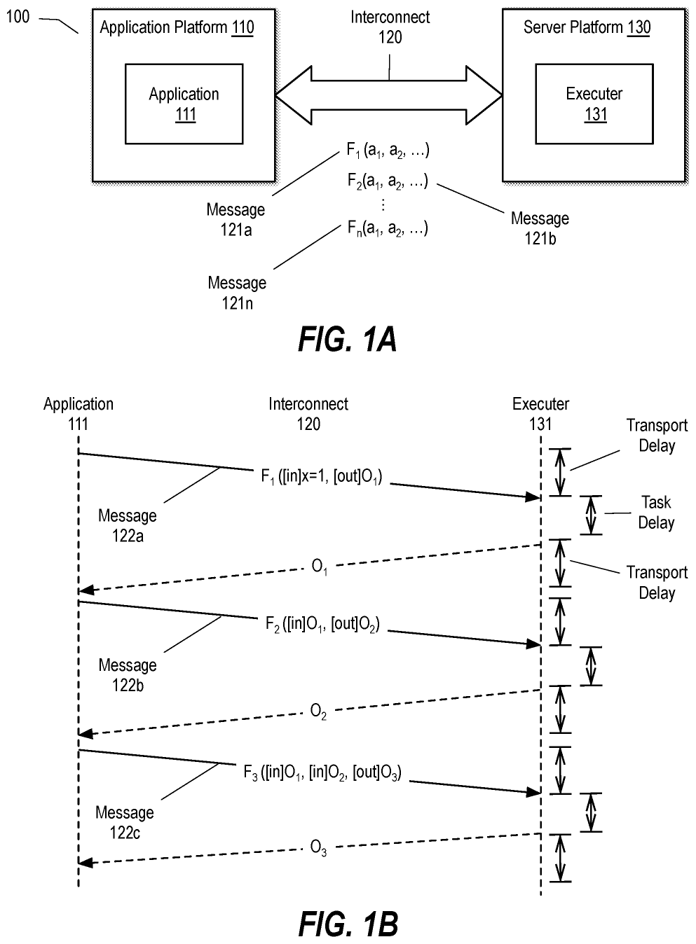

Embodiments described herein are generally directed to improving performance of a transactional API protocol by adaptively optimizing function call performance at runtime. As illustrated by the example described below with reference to FIGS. 1A-B, invoking multiple function calls of a transactional API protocol over a network or other high-latency interconnect in order to have a unit of work performed remotely, introduces undesirable latency and network resource usage.

FIG. 1A is a block diagram illustrating actors involved in a transactional API protocol. In the context of FIG. 1A, an application platform 110 and a server platform 130 are coupled via an interconnect 120. The application platform 110 may represent a first computer system and the server platform 130 may represent a second (remote) computer system. Alternatively, the application platform 110 may represent a first compute resource (e.g., a CPU) of a computer system and the server platform 130 may represent a second compute resource (e.g., a GPU) on the same computer system. In the case of the former, the interconnect 120 may represent a network. In the case of the latter, the interconnect 120 may represent a peripheral component interconnect express (PCIe) bus. In either case, the interconnect 120 typically represents a performance bottleneck as the transport latency is relatively higher than as compared to communications performed within the application platform 110 or within the server platform 130.

An application 111 running on the application platform originates function calls and an executer 131 within the server platform 130 performs the work associated with the function calls. In the context of the present example, it is assumed an atomic unit of work is performed by the executer 131 responsive to a prescribed sequence of function calls (i.e., F₁(a₁, a₂, . . . ), F₂(a₁, a₂, . . . ), . . . Fₙ(a₁, a₂, . . . )) of a transactional API protocol originated by the application 111, in which each function call is sent across the interconnect 120 via a separate message (i.e., message 121a, 121b, and 121n, respectively).

FIG. 1B is a message sequence diagram illustrating delays incurred in connection with an exchange of messages of a transactional API protocol between an application (e.g., application 111) and an executer (e.g., executer 131). In the context of the present example, an ordered sequence of function calls (F₁, F₂, and F₃) is originated by the application and sent via the interconnect 120 to the executer. Message 122a (which may be analogous to message 121a) represents a request on behalf of the application for the executer to remotely execute a function (F₁). F₁ includes two arguments, an immediate input passed as a literal constant and an output variable argument (O₁). Similarly, message 122b (which may be analogous to message 121b) represents a request on behalf of the application for the executer to remotely execute a function (F₂). F₂ includes two arguments, an input variable argument (O₁) and an output variable argument (O₂). Likewise, message 122c (which may be analogous to message 121c) represents a request on behalf of the application for the executer to remotely execute a function (F₃). F₃ includes three arguments, an input variable argument (O₁), an input variable argument (O₂), and an output variable argument (O₃).

In this example, it can be seen that F₂ has a dependency on the output O₁ from the preceding F₁ call. Similarly, F₃ is dependent on F₁ and F₂ for the values of O₁ and O₂, respectively. Further assume that O₃ is the only output that the application cares about the value of (i.e., it is the result of the atomic work task). From this example, it can be seen, the transport API protocol incurs a transport delay for every function call. In addition, an interconnect bandwidth penalty is added for each output variable argument returned across the interconnect 120 that is not required by the application. In this case, O₁ and O₂ (representing intermediate variable arguments) are simply passed to the Executer.

As can be seen from FIG. 1B, a significant source of latency and/or network utilization is the transport of the request/response data. Performance gains could be achieved if multiple functions could be sent in one message. For example, in certain use cases an API flow may be optimized by queuing requests locally (i.e., creating batches of function calls) and sending a list of the collected requests as a single atomic unit. This reduces the number of messages but does not reduce the amount of data transmitted across the wire.

In various examples described herein a “named batch” is a means by which a sequence of commands can be described in a templatized fashion on a remote compute resource (e.g., a server). Templatized batches may reside on the remote compute resource and can be associated with a symbolic name. The client then provides the argument values and the name when requesting the named batch to be carried out by the remote compute resource.

Various embodiments described herein seek to reduce an amount of data transmitted over an interconnect between an application running on the client and an executer running on or represented by the remote compute resource as part of the application issuing requests associated with a transactional API to the executer. As described further below, in one embodiment, a command stream that includes function calls to be carried out by the executer on behalf of the application is monitored. After identifying a sequence of multiple function calls that represents a batch and satisfies a set of one or more criteria, a templatized version of the batch (i.e., a named batch) having a symbolic name and including placeholders for a subset of variable arguments (e.g., excluding those representing intermediate variable arguments and those representing output variable arguments) of the multiple function calls. After observing a subsequent occurrence of the sequence within the command stream, the executer may be caused to carry out the sequence by simply transmitting the symbolic name and values for the subset of variable arguments via the interconnect.

Additionally, in some embodiments, the system may continuously adaptively optimize itself at runtime by evaluating historical usage of the transactional API. For example, the system may save the current named batch space to a profile and restore a different one responsive to a transition from a first distinct usage pattern (e.g., data collection during business hours) to a second distinct usage pattern (e.g. processing of the collected data after business hours). This enables the system to adapt to deterministic changes in use, for example, based on time of day. As profiles are reactivated, they may continue to adapt where they left off.

In one embodiment, an API-aware component operable on the application platform (e.g., the application itself or a library, supplied by the application platform or the transactional API protocol provider) makes use of its awareness of the transaction API protocol to facilitate the batching by classifying the type of functions associated with the respective function descriptors as dependent or terminating (or terminal). A dependent function may represent a function that starts a prescribed sequence of multiple function calls or an intermediate function call of the prescribed sequence and a terminating (or terminal) function may represent a function that ends the prescribed sequence.

In the following description, numerous specific details are set forth in order to provide a thorough understanding of example embodiments. It will be apparent, however, to one skilled in the art that embodiments described herein may be practiced without some of these specific details.

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, an “application” generally refers to software and/or hardware logic that originates function requests of a transactional API protocol.

As used herein, a “function descriptor” generally refers to a transmissible record describing a single function invocation of a transactional API protocol. A function descriptor may include one or more of a function identifier (ID) (e.g., a unique string representing the name of the function) corresponding to the command, a function type (e.g., dependent or terminating), and a global memory reference for each variable argument of the function.

As used herein, the phrase “global memory reference” generally refers to a token that identifies argument data storage. A given global memory reference uniquely identifies the same value on all platforms (e.g., an application platform and a server platform) on which it is used.

As used herein, an “executer” generally refers to software and/or hardware logic that performs the work described by a function descriptor. An executer may represent a compute service or resource remote from the application on behalf of which it performs the work.

As used herein, a “batch” generally refers to a list of function descriptors.

As used herein, a “named batch” generally refers to a templatized version of a batch. A templatized version of a batch or a named batch may include a symbolic name and placeholders for a subset of variable arguments of the associated function calls.

As used herein, an “interconnect” generally refers to any physical or logical mechanism for transmitting data suitable for implementing a function descriptor. Non-limiting examples of an interconnect include a network or a PCIe bus.

As used herein, the phrase “transactional API protocol” generally refers to an interface scheme that makes use of RPCs in which performance of an atomic unit of work involves invoking a prescribed sequence of function calls. This is in contrast to an interface that uses a single function to perform a work task. A transactional API may be implemented in the form of various types of RPC platforms or frameworks, including representational state transfer (REST), gRPC, and graph query language (GraphQL). Non-limiting examples of transactional API protocols include Intel oneAPI, compute unified device architecture (CUDA), and open computing language (OpenCL).

As used herein, the term “profile” generally refers to a collection of settings, information, and/or data associated with a particular usage pattern of a transactional API. According to one embodiment, the system may include multiple profiles each corresponding to a distinct usage pattern of the transactional API. A profile may include metrics and/or other information relating to historical usage of the transactional API and/or other runtime data used to create and/or retire (remove) named batches. Alternatively or additionally, a profile may include a batch space including definitions (or templates) of named batches as well as a set of one or more default and/or user-defined criteria that may be used to determine whether to create a new named batch and/or remove an existing named batch. In some embodiments, the system may continuously adaptively optimize itself at runtime by evaluating historical usage of the transactional API, including, for example, saving the current named batch space to a currently active profile and restoring a different profile associated with a different usage pattern of the transactional API.

The terms “component”, “platform”, “monitor,” “optimizer,” “system,” “scheduler,” “manager” and the like as used herein are intended to refer to a computer-related entity, either a software-executing general purpose processor, hardware, firmware, or a combination thereof. For example, a component may be, but is not limited to being, a process running on a compute resource, an object, an executable, a thread of execution, a program, and/or a computer.

### Example Operational Environment

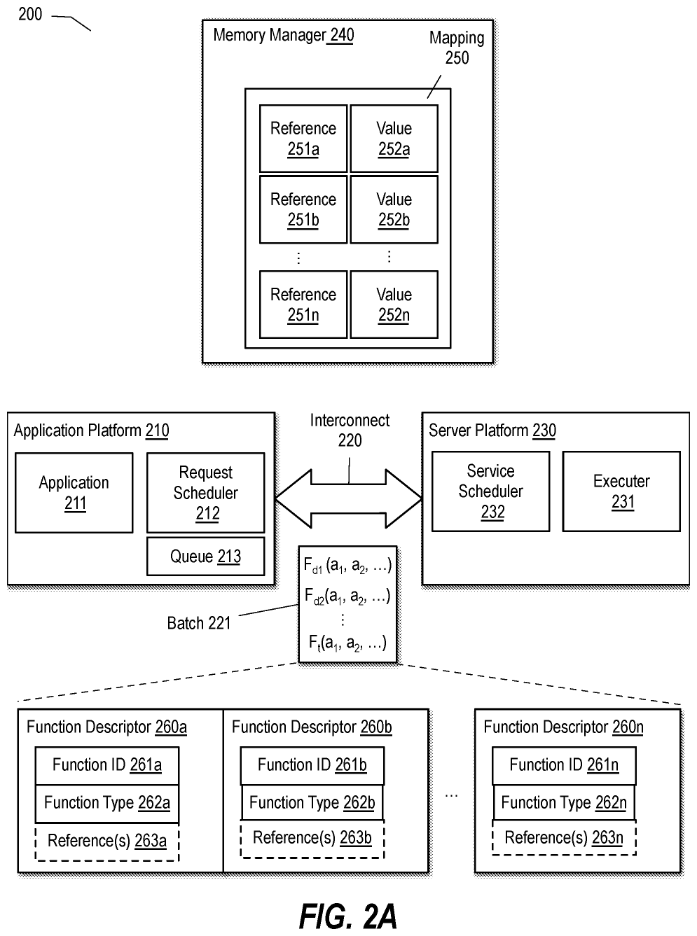

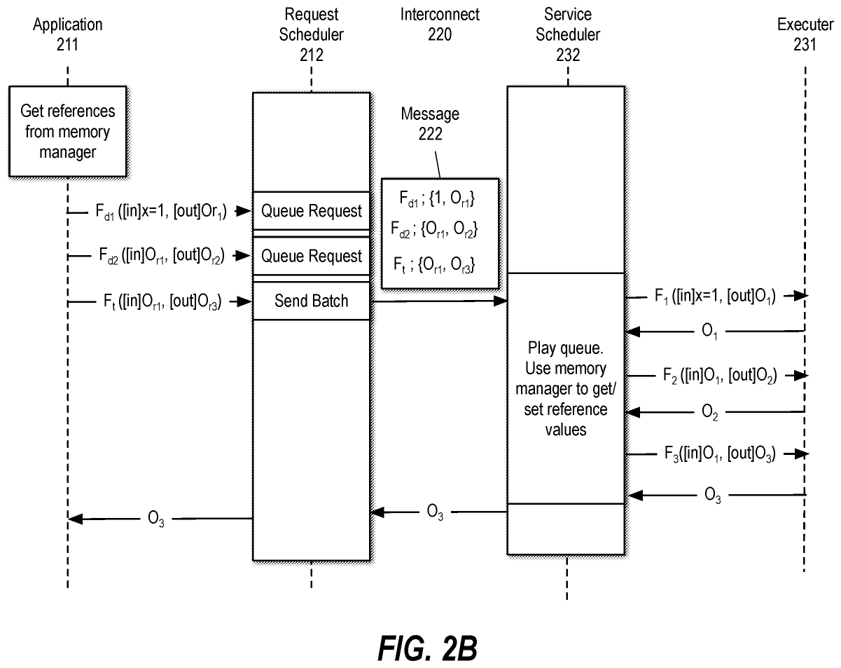

FIG. 2A is a block diagram illustrating an operational environment 200 supporting batch scheduling of function calls of a transactional API protocol according to some embodiments. In the context of the present example, the operational environment 200 is shown including an application platform 210, an interconnect 220, a server platform 230, and a memory manager 240. As above, the application platform 210 may represent a first computer system and the server platform 230 may represent a second (remote) computer system. Alternatively, the application platform 210 may represent a first compute resource (e.g., a CPU) of a computer system and the server platform 230 may represent a second compute resource (e.g., a GPU) on the same computer system. When the application platform 210 and the server platform 230 are separate computer systems, the interconnect 220 may represent a network. When the application platform 210 and the server platform 230 are within the same computer system, the interconnect 220 may represent a PCIe bus or a compute express link (CXL) interconnect. As explained above with reference to FIG. 1A, in either case, the interconnect 220 typically represents a performance bottleneck as the transport latency is relatively higher than as compared to communications performed within the application platform 210 or within the server platform 230.

The application platform 210 is shown including an application 211, a request scheduler 212, and a queue 213. The application 211 may represent software and/or hardware logic that originates function requests. The request scheduler 212 may insulate the application 211 from details associated with batch of sequences of function calls. Alternatively, the request scheduler 212 may be part of the application 210. The request scheduler 212 may be responsible for queuing function requests (e.g., function calls that start or represent intermediate function calls of a prescribed sequence of multiple function calls that are used together to perform an atomic unit of work) on the queue 213 and transmitting them as a batch (e.g., batch 221) along with the function call (e.g., a terminating function call) that ends the prescribed sequence to the service scheduler 232 via the interconnect 220. As shown in FIG. 2A, the batch 211 may be represented in the form of a list of function descriptors 260a-n each containing respective function IDs 261a-n, function types 262a-n.

The server platform 230 is shown including a service scheduler 232 and an executer 231. The executer 231 may represent software and/or hardware logic that performs the work described by a function descriptor. The service scheduler 232 may be responsible for scheduling the execution (replay) of the functions within a batch received from the request scheduler 212 by the executer 231. The service scheduler 212 may insulate the executer 231 from details associated with the notion of batches as well as the use of the memory manager 240 and global memory references. Alternatively, the service scheduler 232 may be part of the executer 231.

The memory manager 240 may represent software and/or hardware logic that manages allocation and access to memory based on a global memory reference. For example, the memory manger 240 may be used to get and set values (e.g., values 250a-n) for respective global memory references (e.g., references 251a-n) assigned by the memory manager 240. Each global memory reference may represent a token that uniquely (at least within a given batch) identifies data storage for a given variable argument of a function. For example, a mapping 250 (e.g., a key-value store or like data structure) may be used to map a given global memory reference to a given value. The global memory references may serve as place holders for the real values of input and/or output variable arguments of functions that are yet to be computed, thereby allowing an output variable argument of one function of a batch (e.g., batch 221) to be forward referenced by an input variable argument of subsequent function of the batch. The memory manager 240 may be implemented as a single centralized service (e.g., a microservice) or daemon or as multiple distributed components.

FIG. 2B is a message sequence diagram illustrating interactions among various actors involved in performing batch scheduling of multiple function calls of a transactional API protocol according to some embodiments. The application 211 may use a function descriptor (e.g., one of function descriptors 260a-n) to describe each function request and its arguments. Arguments may be immediate or variable. Immediate arguments are inputs passed as literal constants. Variable arguments are arguments whose value can change after creation (e.g., as a result of a previous function request or in the case of an input buffer, by the application 211). Variable arguments may be further typed as input or output and are represented via respective global memory references, which are provided by a memory manager (e.g., memory manager 240).

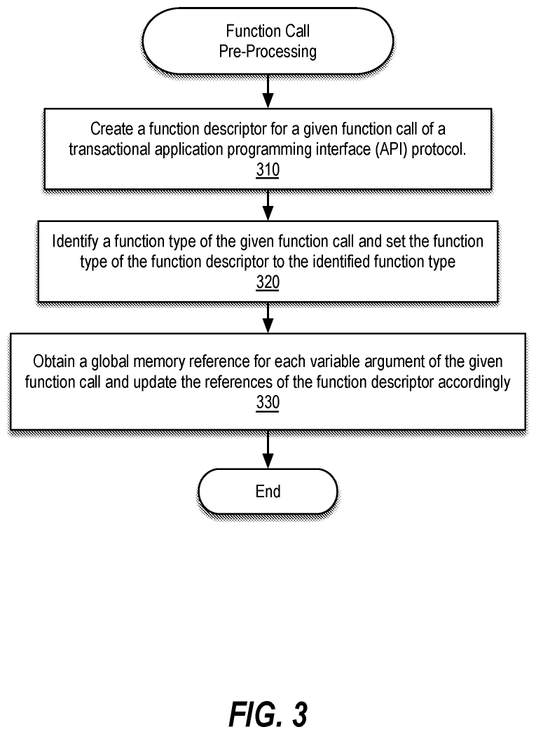

In the context of the present example, the application 211 schedules a remote function by creating a function descriptor for the function to be invoked. Function call pre-processing performed by or on behalf of the application 211 may create references (e.g., global memory references) for all variable arguments. For variable input arguments, the application sets their respective values prior to sending the function request. Function descriptors may include a function ID, a function type, and all immediate and reference arguments (e.g., Oᵣ₁, Oᵣ₂, and Oᵣ₃). Function call pre-processing is described further below with reference to FIG. 3.

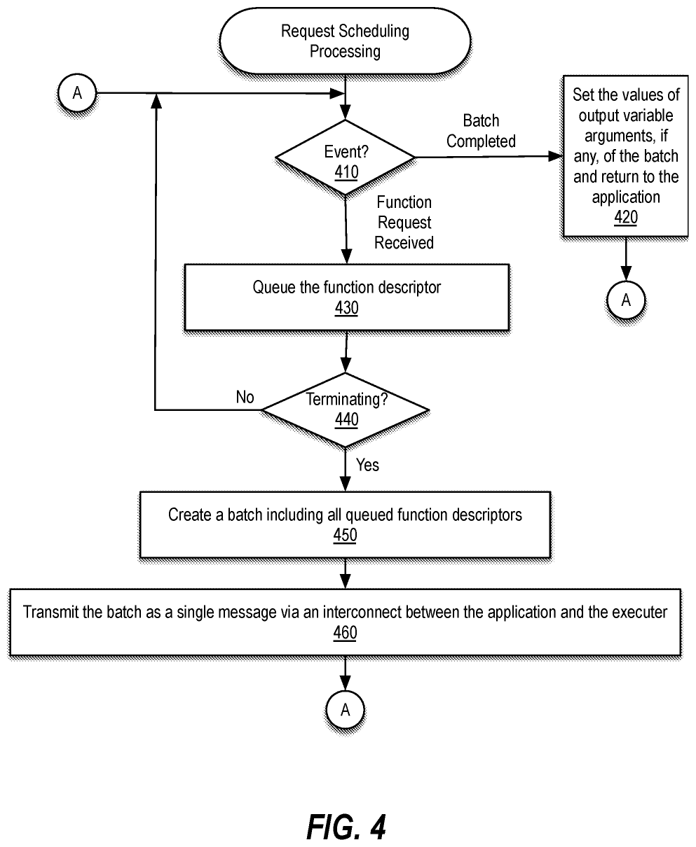

Responsive to receipt of function requests, the request scheduler 212 may perform request scheduling processing. The request scheduling processing may include delaying sending of function descriptors of dependent functions (e.g., F_{d1} and F_{d2}) and a terminating function (e.g., Fₜ) until after receipt of the function descriptor of the terminating function at which point a batch including the function descriptors for an entire prescribed sequence may be transmitted to the service scheduler 232 via the interconnect 220 as a single message 222. Further description of request scheduling processing is described below with reference to FIG. 4.

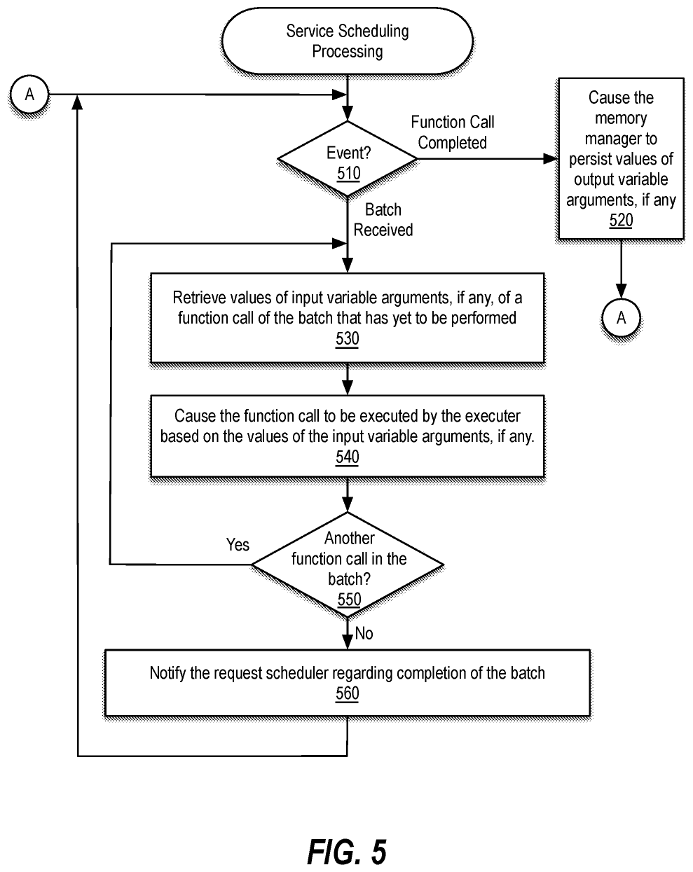

When the service scheduler 232 receives the batch (e.g., message 222), it performs service scheduling processing. The service scheduling may include for each function descriptor in the batch, replacing reference arguments (e.g., Oᵣ₁, Oᵣ₂, and Oᵣ₃) with values provided by the memory manager. Upon conclusion of execution of a function descriptor by the executer 231, output data represented as references (e.g., Oᵣ₁, Oᵣ₂, and Oᵣ₃) are stored via the memory manager. Further description of service scheduling processing is described below with reference to FIG. 5.

In one embodiment, as a further optimization, the concept of a named batch may be utilized. In the previous example, the request scheduler 212 aggregates function descriptors into a batch and then transmits the contents of the batch to the service scheduler 232 for execution. A named batch allows a common sequence of function requests to be recorded or pre-defined and stored on the server platform 230. For example, each pre-defined batch may be associated with a symbolic name and a function descriptor. The function descriptor for a named batch may be limited to information regarding immediate arguments (e.g., O₁ and O₂) and the final output variable argument (e.g., O₃) of the function descriptor. The intermediate variable arguments may remain on the server platform 230 and thus may be invisible to the application 211.

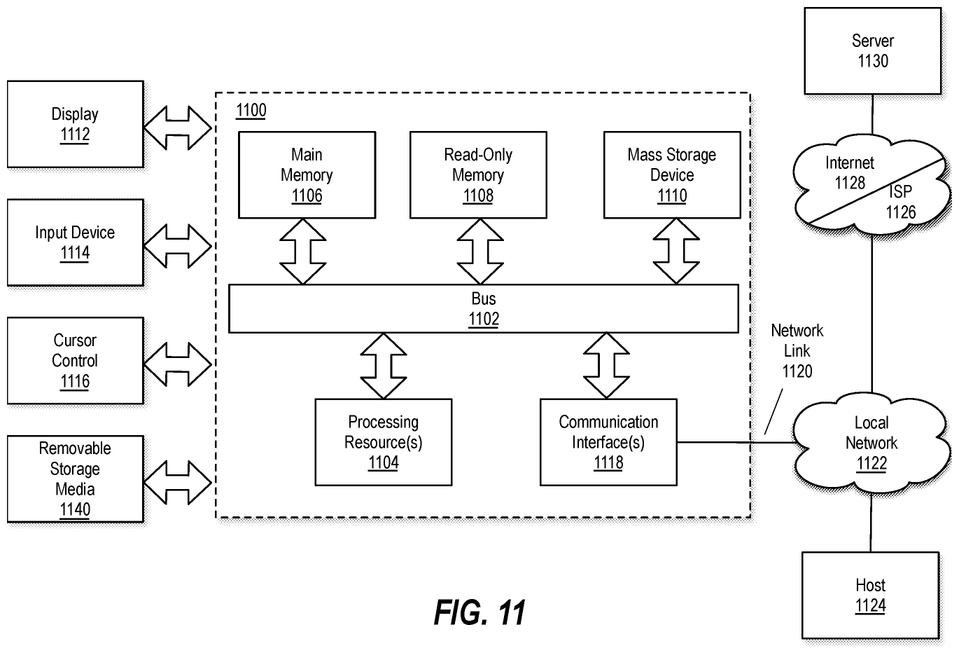

The schedulers of FIG. 2A and the processing described below with reference to the flow diagrams of FIGS. 3-5 may be implemented in the form of executable instructions stored on a machine readable medium and executed by a processing or compute resource (e.g., a microcontroller, a microprocessor, a CPU, a CPU core, a GPU, a GPU core, an ASIC, an FPGA, or the like) and/or in the form of other types of electronic circuitry. For example, the processing may be performed by one or more virtual or physical computer systems of various forms, such as the computer system described below with reference to FIG. 11.

### Example Function Call Pre-Processing

FIG. 3 is a flow diagram illustrating operations for performing function call pre-processing according to some embodiments. In one embodiment, function call pre-processing includes creation of a function descriptor for a given function call of a transactional API protocol prior to invocation of the given function call or as part of the invocation of the given function call by an application (e.g., application 211). The processing described with reference to FIG. 3 may be performed by an API-aware component. The API-aware component may be part of the application itself or may be a library or companion optimization plug-in supplied by an application platform (e.g., application platform 210) on which the application runs or supplied by the provider of the transactional API protocol.

At block 310, a function descriptor (e.g., function descriptor 260a) is created for the given function call. In one embodiment, the function descriptor represents a transmissible record describing invocation of the given function call and includes one or more of a function ID (e.g., function ID 261a), a function type (e.g., function type 262a), and one or more global memory references (e.g., references 263a). The function ID may be a unique string representing the name of the function or command to be carried out by the executer (e.g., executer 231). The function type may be one of multiple function types. The multiple function types may be indicative of whether the given function represents the start or an intermediate step (e.g., the given function call is a dependent function type) of a given prescribed sequence of function calls or the end (e.g., the given function call is a terminating function type) of the given prescribed sequence of function calls.

At block 320, a function type of the given function call is identified by the API-aware component and the function type of the function descriptor is set to the identified function type. In one embodiment, the API-aware component has knowledge of prescribed sequences of function calls of a transactional API protocol that may be batched together including which of the function calls are dependent and which are terminating. Alternatively or additionally, the API-aware component may apply a set of rules (e.g., including whether a function has an output argument whose value the application may have a dependency on) to classify and label a given function call as dependent or terminating within the function descriptor. Based on the knowledge of the prescribed sequences of function calls and/or the set of rules, the function type of the given function call may be identified from among the multiple function types.

At block 330, a global memory reference is obtained for each variable argument associated with the given function call and the references of the function descriptor are set to corresponding global memory references. For example, the API-aware component may loop through all arguments of the given function call and when the argument represents a variable arguments, the API-aware component may request a new global memory reference for the variable argument and include the new global memory reference within the function descriptor.

The following is a simplified and non-limiting example of a sequence of oneAPI Level-Zero API calls to copy a buffer. In this example it can be seen there are several dependencies. Note that the zeEventCreate function depends on the value of the event_pool, which is set via the prior zeEventPoolCreate call. Further the zeCommandListAppendMemoryCopy is dependent on the zeCommandListAppendMemoryCopy call, which is dependent on the kernel_event returned from zeEventCreate. Finally note that the application does not do anything with the values of event_pool or kernel_event other than to pass them to the dependent function. Therefore, this grouping of functions could be bundled into a Batch.

```
zeMemAllocDevice(context, &dev_desc,
vectSize,
  1,
  pDevice,
  reinterpret_cast<void**>(&devptr));
status = zeMemAllocHost(context,
    &host_desc,
    vectSize,
    1,
    &fwhostptr);
status = zeEventPoolCreate(context, &ep_desc,
      1,
      &pDevice,
      &event_pool);
status = zeEventCreate(event_pool, &ev_desc, &kernel_event);
status = zeCommandListAppendMemoryCopy(command_list,
hostptr,
devptr,
vectSize,
        kernel_event,
        0,
        nullptr);
```

### Example Request Scheduling

FIG. 4 is a flow diagram illustrating operations for performing request scheduling according to some embodiments. In one embodiment, request scheduling is performed by a request scheduler (e.g., request scheduler 212) after an event is received that is indicative of completion of execution of a batch or an event that is indicative of receipt of a function request, for example, in the form of a function descriptor. A notification of completion of the batch may be sent from a service scheduler (e.g., service scheduler 232) to the request scheduler. The function request may be received directly from an application (e.g., application 211) or via an API-aware component (e.g., a library or companion optimization plug-in associated with the transactional API protocol) logically interposed between the application and the request scheduler.

At decision block 410, a determination is made regarding what the event represents. If the event represents completion of execution of all function calls associated with a previously submitted batch, processing branches to 420; otherwise, when the event represents receipt of a function request, processing continues with block 430.

At block 420, the values of output variable arguments of the completed batch are set and returned to the application. For example, the request scheduler may obtain the values of the output variable arguments of the batch from a memory manager (e.g., memory manager 240). Following block 420, request scheduling processing may loop back to decision block 410 to process the next event.

At block 430, the function descriptor is queued. For example, the request scheduler adds the function descriptor to queue 213.

At decision block 440, the function type of the function descriptor is evaluated. If the function type is terminating, indicating the function descriptor represents the end of a prescribed sequence of function calls, then processing continues with block 450; otherwise, if the function type is dependent, indicating the function descriptor represents either a start of the prescribed sequence or an intermediate step in the prescribed sequence, then processing loops back to decision block 410 to process the next event.

At block 450, a batch is created including all the queued function descriptors. In one embodiment, the batch is represented in the form of a list of function descriptors.

At block 460, the batch is transmitted as a single message via an interconnect (e.g., interconnect 220) between an application platform (e.g., application platform 210) on which the application is running and a server platform (e.g., server platform 230) including an executer (e.g., executer 231). Following block 460, request scheduling processing may loop back to decision block 410 to process the next event.

While the present example, it is assumed the application requesting thread implements a non-blocking asynchronous model, those skilled in the art will appreciate in a blocking model, the application requesting thread will block until the batch is complete.

### Example Service Scheduling

FIG. 5 is a flow diagram illustrating operations for performing service scheduling according to some embodiments. In one embodiment, service scheduling is performed by a service scheduler (e.g., service scheduler 232) after an event is received that is indicative of receipt of a batch transmitted by a request scheduler (e.g., request scheduler 212) via an interconnect (e.g., interconnect 220) or an event that is indicative of completion of execution of a given function call by an executer (e.g., executer 231).

At decision block 510, a determination is made regarding what the event represents. If the event represents completion of execution of a given function call, processing branches to 520; otherwise, when the event represents receipt of a batch transmitted by the request scheduler, processing continues with block 530.

At block 520, a memory manager (e.g., memory manager 240) is caused to persist value of output variable arguments of the completed function call. For example, the service scheduler may process each output variable argument and cause the memory manager to set the value of the output variable argument based on the corresponding global memory reference. Following block 520, service scheduling processing may loop back to decision block 510 to process the next event.

At block 530, the values of input variable arguments of the first/next unprocessed function call of the batch of function descriptors are retrieved. For example, for a given reference argument, the service scheduler may utilize the memory manager to acquire the value associated with the corresponding global memory reference. Input variable arguments will have the last valid value set. In one embodiment, the memory manager ensures the correctness of the data. According to one embodiment, for every reference argument, the service scheduler enables locally accessible storage be made available for that argument within a server platform (e.g., server platform 230) that includes the service scheduler and the executer.

At block 540, the given function call is caused to be executed by the executer based on the values of the input variable arguments. For example, the service scheduler may examine the function descriptor and determine the name/ID of the function to invoke. Immediate data may be passed to the executer unmodified. For reference arguments, the service scheduler may pass the values obtained in block 550. Upon conclusion of execution a function descriptor, output data represented as references will be stored via the memory manager in block 520.

At decision block 550, it is determined whether another function call remains to be processed in the batch. If so, processing loops back to block 530; otherwise, processing continues with block 560.

At block 560, the request scheduler is notified regarding completion of the batch. For example, the service scheduler may transmit the corresponding global memory reference for each output variable argument of the batch (excluding those representing intermediate data). Following block 560, service scheduling processing may loop back to decision block 510 to process the next event.

### Example Operational Environment for Named Batches

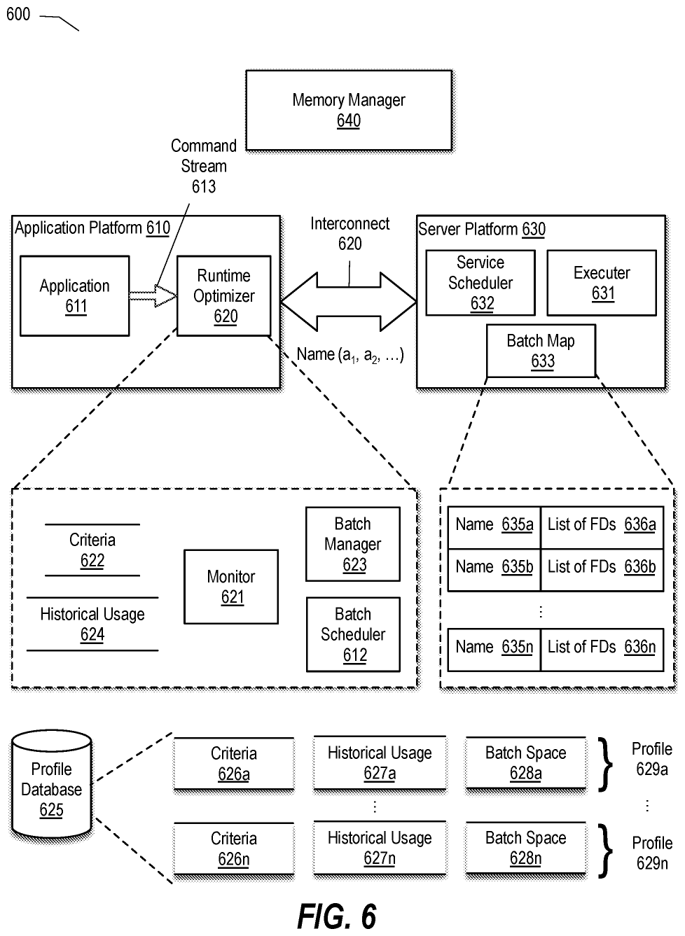

FIG. 6 is a block diagram illustrating an operational environment 600 supporting creating and use of named batches for function calls of a transactional API protocol according to some embodiments. In the context of the present example, the operational environment 600 is shown including an application platform 610 (which may be analogous to application platform 210), an interconnect 620 (which may be analogous to interconnect 210), a server platform 630 (which may be analogous to server platform 230), a memory manager 640 (which may be analogous to memory manager 240), and a profile database 625.

The application platform 610 is shown including an application 611 (which may be analogous to application 211) and a runtime optimizer 620. In the context of the present example, function calls issued directly or indirectly by the application 611 and received by the runtime optimizer 620 are referred to as a command stream 613. The runtime optimizer 620 may be responsible for, among other things, scheduling a sequence of function requests invoked by the application 611 for execution on the server platform 630 and monitoring the command stream 613 to identify candidate batches for which a named batch is to be created. The runtime optimizer 620 may include a criteria data store 622, a historical usage data store 624, a monitor 621, a batch manager 623, and a batch scheduler 612 (which may be analogous to request scheduler 212).

The criteria data store 622 may include a set of one or more criteria that may be used to determine whether to create a new named batch and/or remove an existing named batch. A non-limiting example of a criterion that may be used to trigger creation of a new named batch is frequency of occurrence of a given sequence of function calls within the command stream 613, for instance, during a period of time (e.g., minute, hour, day). Depending upon the particular usage model, the satisfaction of one or more additional criterion may be used separately and/or in combination with frequency to trigger creation of a new named batch.

The historical usage data store 624 may include metrics (e.g., counters, statistics, etc.) relating to observations of various sequences of function calls within the command stream 613. The runtime optimizer 620 may make use of the historical usage data store 624 to evaluate a set of one or more criteria in connection with making a determination to create a new named batch and/or remove an existing named batch.

The monitor 621 may be responsible for continuously monitoring the command stream 613, including translating recognized known sequences of function calls into named batch requests and creating and/or retiring named batches through the batch manager 623. The batch manager 623 may be responsible for interacting with the server platform 630 to create and/or retire named batches.

According to one embodiment, as function requests (e.g., in the form of function descriptors) arrive at the runtime optimizer 620 they pass through the monitor 621. The monitor 621 may examine the function requests as they arrive, looking for one of two things: (i) a known sequence defined within the current (or active) profile this is associated with an existing named batch; or (ii) satisfaction of a set of one or more criteria to establish a given sequence of function requests as a named batch in the current profile.

If the monitor 621 determines that an existing named batch has been detected within the command stream 631, it may create a function descriptor for the named batch associated with the detected sequence and may pass it along with the relevant input argument values to the batch scheduler 612 where the named batch request may be transmitted to the server platform 630 as a single message.

If the monitor 621 determines that the function is not a part of an existing or a “known” named batch within the active profile but satisfies the criteria for selection as a new named batch, it may send the function request to the batch manager 623 where a new named batch will be created for the batch in the current profile, for example, as the batch request is transmitted to the server platform 630. Subsequent occurrences of the sequence (now, an existing named batch) may then be detected by the monitor 621.

If the monitor 62 determines that the function request neither satisfies the set of one or more criteria for establishment as a new named batch nor is associated with an existing named batch, then the function request may be sent to the batch scheduler to be sent to the server platform 630 as an individual function descriptor.

The server platform 630 is shown including a service scheduler 632 (which may be analogous to service scheduler 232), an executer 631 (which may be analogous to executer 231), and a batch map 633. The batch map 633 may represent a batch space including the named batches that are currently defined and available for use by the system, for example, in the active profile. Each named batch may include a symbolic name (e.g., one of names 635a-n) and corresponding function descriptors (e.g., one of the lists of function descriptors 636a-n). The named batches may be represented in the form of templates on the server platform 630 in which placeholders are used for a subset of the variable arguments (i.e., input variable arguments that do not represent intermediate variable arguments) of the function descriptors and are replaced by corresponding values (e.g., immediate values and/or global memory references) provided by the platform 610. This allows a named batch request (e.g., BatchName(Name, arg1, arg2, . . . )) to be transmitted by the batch scheduler in place of a batch (e.g., a list of multiple function descriptors). In this manner, the application platform 610 may cause a known sequence of function calls for which a named batch has previously been created to be executed on the server platform 630 by transmitting the symbolic name and values of the placeholders (e.g., as part of a single function descriptor representing the named batch request), thereby reducing the amount of data transferred via the interconnect 620.

The profile database 625 may include information regarding multiple profiles (e.g., profile 692a-n). Each profile may be associated with a distinct usage pattern of a transactional API by an application (e.g., application 611), for example, associated with different times of day. In the context of the present example, each profile 629a-n is shown including a set of one or more criteria (e.g., one of criteria data stores 626a-n), historical usage data (e.g., one of historical usage data stores 627a-n), and a batch space (e.g., batch space 628a-n). In some embodiments, the system may continuously adaptively optimize itself at runtime by evaluating historical usage of the transactional API, including, for example, identifying multiple distinct and predictable usage patterns, creating a profile for each distinct and predictable usage pattern, and swapping profiles in and out as the usage pattern changes. According to one embodiment, profiles may be swapped by the batch manager 623 performing a local database swap and then notifying the batch scheduler 612 to swap profiles. The batch scheduler 612 may be responsible for insuring a synchronized switch with the server platform 630

Assuming, for sake of illustration, historical usage of application 611 exhibits two distinct and predictable usage patterns—a first usage pattern that commences at 8:00 AM daily and a second usage pattern that commences at 5:00 PM daily, such a deterministic change in usage may be accommodated by maintaining and swapping between two profiles. For example, at 5:00 PM each day, a first profile (e.g., profile 629a) associated with the first usage pattern may be saved and a second profile (e.g., profile 629n) associated with the second usage pattern may be restored. Similarly, at 8:00 AM each day, the second profile may be saved and the first profile may be restored. This enables the system to adapt to deterministic changes in use, for example, based on time of day. As profiles are reactivated, they may continue to adapt where they left off.

In general, saving a given profile may involve persisting relevant portions of the current runtime state to corresponding portions of the given profile. Specifically, in the context of the present example, saving a given profile may involve persisting the current state of the criteria data store 622, the historical usage data store 624, and the batch map 633 to a criteria data store (e.g., one of criteria data stores 626a-n), a historical usage data store (e.g., one of historical usage data stores 627a-n), and a batch space (e.g., batch space 628a-n), respectively, of the given profile. Similarly, restoring a given profile may involve updating relevant portions of the runtime state with corresponding portions of the given profile. Specifically, in the context of the present example, restoring a given profile may involve updating criterial data store 622, historical usage data store 624, and batch map 633 with a criteria data store (e.g., one of criteria data stores 626a-n), a historical usage data store (e.g., one of historical usage data stores 627a-n), and a batch space (e.g., batch space 628a-n) of the give profile.

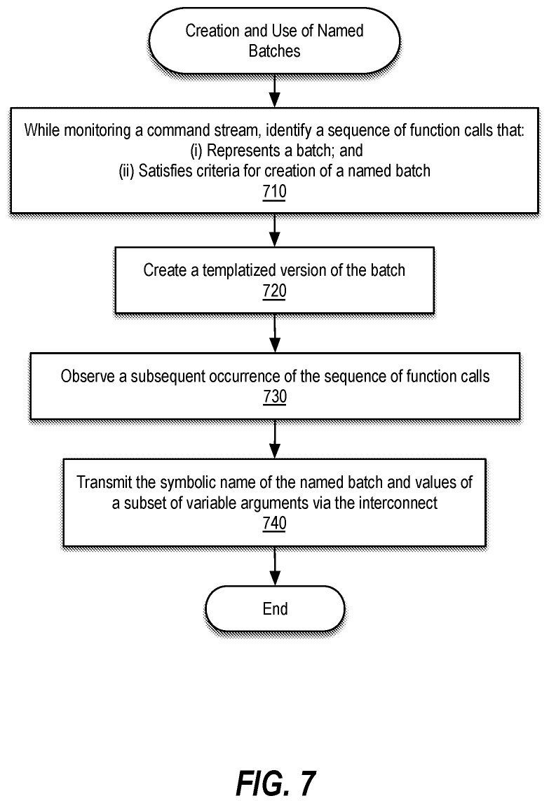

Various of the functional units depicted in FIG. 6 and the processing described below with reference to the flow diagrams of FIGS. 7-10 may be implemented in the form of executable instructions stored on a machine readable medium and executed by a processing or compute resource (e.g., a microcontroller, a microprocessor, a CPU, a CPU core, a GPU, a GPU core, an ASIC, an FPGA, or the like) and/or in the form of other types of electronic circuitry. For example, the processing may be performed by one or more virtual or physical computer systems of various forms, such as the computer system described below with reference to FIG. 11.

### Example Creation and Use of Named Batches

FIG. 7 is a high-level flow diagram illustrating operations for creation and use of named batches according to some embodiments. The processing described with reference to FIG. 7 may be performed by a runtime optimizer (e.g., runtime optimizer 620) of an application platform (e.g., application platform 610). In general, when a given batch is first identified as one to be optimized by creating a new named batch, it may be handled as a batch and a new named batch may be concurrently created (e.g., CreateBatch(Name, Batch)). Thereafter (unless and until the named batch is retired), subsequent occurrences of the prescribed sequence of function calls associated with the named batch may be detected and data reduction may be achieved by transmitting a named batch request to a server platform (e.g., server platform 630).

At block 710, while monitoring a command stream (e.g., command stream 613), a sequence of function calls is identified that (i) represents a batch and (ii) satisfies criteria for creation of a named batch. As noted above, in one embodiment, an API-aware component operable on the application platform (e.g., the application itself or a library, supplied by the application platform or the transactional API protocol provider) may make use of its awareness of the transaction API protocol to facilitate batching of prescribed sequences of multiple function calls into respective batches, for example, by tagging or labeling corresponding function descriptors (e.g., via a function type field) as dependent or terminating. In this example, after a batch has been identified (and assuming the batch does not already represent a named batch), a set of one or more criteria (e.g., new batch selection criteria associated with the active profile) may be evaluated by a monitoring module (e.g., monitor 621), for example, with reference to historical data (e.g., historical usage data store 624) to determine whether the batch at issue represents a candidate for optimization. For example, when the batch is observed within the command stream at a frequency meeting or exceeding a frequency threshold, the batch may be confirmed as a candidate for optimization (a candidate for creation of a new named batch).

At block 720, a new named batch is created for the batch, including creation of a templatized version of the batch. According to one embodiment, creation of the new named batch may involve the monitoring module storing a mapping of the prescribed sequence of function calls to the name of the new batch to facilitate subsequent occurrence of the prescribed sequence of function calls to be identified as an existing named batch. Additionally, responsive to a request by the monitoring module, a batch manager (e.g., batch manager 632) may direct the server platform, concurrently with the transmission of the batch to the server platform, to create the new templatized version of the batch with placeholders for input variable arguments to be supplied during subsequent usage of the named batch.

At block 730, a subsequent occurrence of the prescribed sequence of function calls is observed within the command stream. Based on the mapping created in block 720, the monitoring module may identify the prescribed sequence of function calls as being associated with an existing named batch.

At block 740, the symbolic name of the named batch and values (e.g., immediate values and/or global memory references) of a subset of the variable arguments are transmitted to the server platform.

### Example Command Stream Monitoring

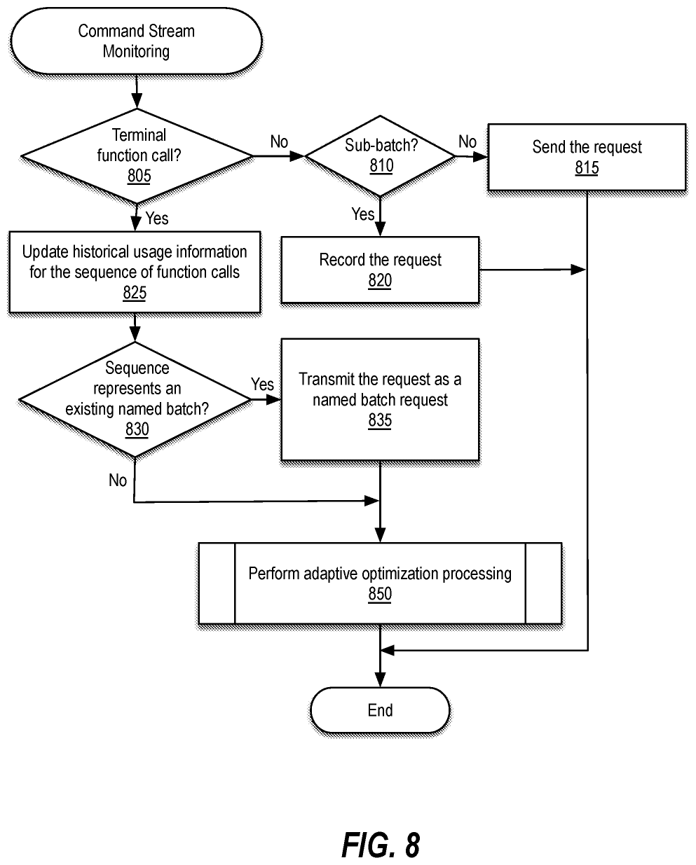

FIG. 8 is a flow diagram illustrating operations for performing command stream monitoring according to some embodiments. The processing described with reference to FIG. 8 may be performed by various components of a runtime optimizer (e.g., runtime optimizer 620) of an application platform (e.g., application platform 610). For example, monitoring of a command stream (e.g., command stream 613) may be performed by a monitoring module (e.g., monitor 621), whereas the transmission of requests (e.g., an individual function calls not associated with a batch, a batch request representing a prescribed sequence of function calls associated with a batch, and a named batch request representing the invocation of those of the function calls associated with an existing named batch) via an interconnect (e.g., interconnect 620) coupling the application platform and a server platform (e.g., server platform 630) in communication may be performed by a batch scheduler (e.g., batch scheduler 612).

At decision block 805, a determination is made regarding whether the current function call within the command stream represents a terminal (or terminating) function call. If so, processing continues with block 825; otherwise processing branches to decision block 810.

At decision block 810, a determination is made regarding whether the current function call within the command stream is part of a sub-batch. If so, processing continues with block 820; otherwise processing branches to block 815. According to one embodiment, a sub-batch represents a partial batch of one or more function calls in which receipt of one or more additional function calls have the possibility of completing the batch. For example, assuming, for sake of illustration, the prescribed sequence of function calls {F₁, F₂, and F₃} represents the only batch of function calls for a particular transactional API protocol, if the last function call processed from the command stream was F₁ and the current one is F₂, then these two consecutive function calls represent a sub-batch as the subsequent receipt of F₃ (assuming no other intervening function calls) would complete the batch. Similarly, if the last function call represented a terminal function call or a function call that is not the beginning of a sub-batch and the current one is F₁, then the determination would be affirmative as the subsequent receipt of F₂ followed by F₃ (assuming no other intervening function calls) would complete the batch. In contrast, if the last function call processed was F₄ and the current one is F₅, then the determination would be negative as the receipt of any additional function calls cannot complete the batch.

At block 815, the request is transmitted to the server platform (e.g., server platform 630) and command stream monitoring is complete until another request is present in the command stream.

At block 820, as above in the context of FIG. 4, this request represents either the start of a prescribed sequence of a batch or an intermediate step in the prescribed sequence and is recorded (e.g., queued until the terminal request is received). At this point, command stream monitoring is complete until another request is present in the command stream.

At block 825, responsive to the current function call being a terminal function call of a particular batch, historical usage information for the particular batch is updated. For example, a count for the particular batch may be incremented and a timestamp for the particular batch may be updated.

At decision block 830, a determination is made regarding whether the batch represents an existing named batch. If so, processing continues with block 835; otherwise, processing branches to block 850. According to one embodiment, a data structure may be maintained on the application platform 610 with the prescribed sequences of existing named batches along with their associated symbolic names. Using such a data structure, when the batch at issue matches any of the prescribed sequences associated with an existing named batch, then the determination is affirmative; otherwise, the determination is negative.

At block 835, values (e.g., immediate values and/or global memory references, as appropriate) of the input variable arguments of the named batch (i.e., a subset of the input variable arguments of the multiple function calls that are part of the named batch) are set and the named batch is sent via the interconnect (e.g., interconnect 620) as a named batch request (e.g., a single function descriptor including the values of the input variable arguments of the named batch and the symbolic name of the named batch).

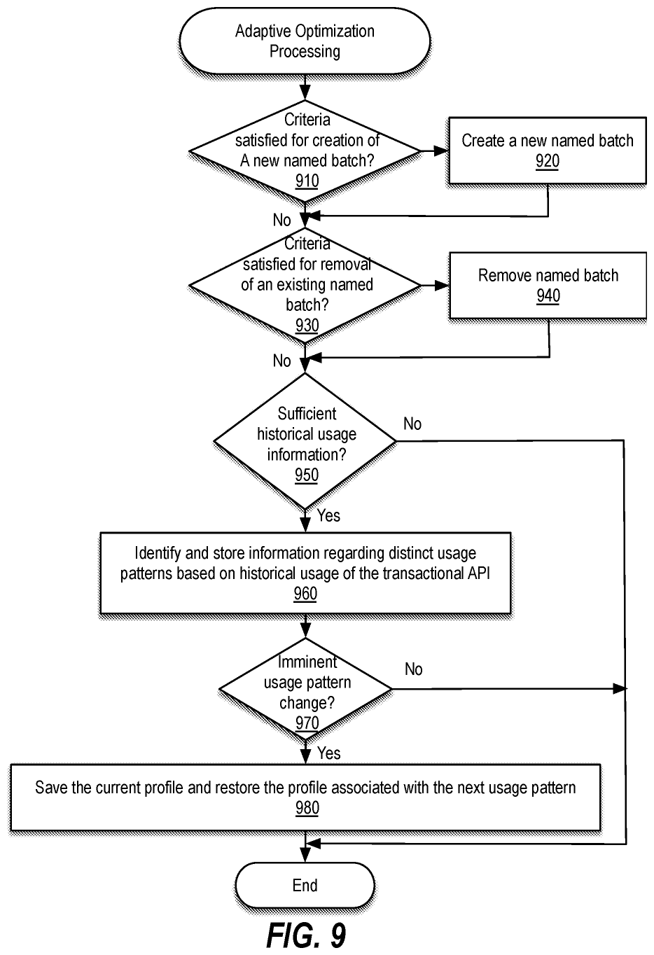

At block 850, adaptive optimization processing may be performed. The adaptive optimization processing may involve, among other things, determining whether to create a new named batch, determining whether to retire an existing named batch, and/or determining whether it is time to perform a profile swap. A non-limiting example of adaptive optimization processing is described further below with reference to FIG. 9.

### Example Runtime Adaptive Optimization Processing

FIG. 9 is a flow diagram illustrating operations for performing adaptive optimization processing according to some embodiments. The processing described with reference to FIG. 9 may be performed by various components of a runtime optimizer (e.g., runtime optimizer 620) of an application platform (e.g., application platform 610). For example, creating a new named batch within the active profile, retiring (removing) an existing named batch from the active profile may be performed by a monitoring module (e.g., monitor 621), whereas the transmission of requests (e.g., a batch request representing a prescribed sequence of function calls associated with a batch but not currently corresponding to an existing named batch) via an interconnect (e.g., interconnect 620) coupling the application platform and a server platform (e.g., server platform 630) in communication may be performed by a batch scheduler (e.g., batch scheduler 612). Depending on the particular implementation, the adaptive optimization processing may be performed responsive to a trigger event, for example, after identifying the current function request within a command stream (e.g., command stream 613) represents a terminal function call (e.g., as part of the “yes” branch exiting decision block 805 of FIG. 8).

At decision block 910, it is determined whether a set of one or more criteria are satisfied by a given sequence of function requests (e.g., terminated by the terminal function detected at decision block 805) for creation of a new named batch. If so, processing branches to block 920; otherwise, processing continues with decision block 930. For example, based on metrics (e.g., batch counters and corresponding timestamps) maintained within historical usage information (e.g., historical usage data store 624), when the batch is observed within the command stream at a frequency meeting or exceeding a frequency threshold, the existing named batch may be confirmed as a candidate for creation of a new named batch.

At block 920, a new named batch may be created. For example, the monitor module may provide a batch manager (e.g., batch manager 623) with a function descriptor, including a symbolic name and values for the input arguments of the batch, for the new named batch associated with the detected sequence of function requests; and responsive to receipt of the request from the monitor module, the batch manager may create the new named batch in the active profile by, for example, sending a create batch request as part of a batch execution request to the server platform.

At decision block 930, it is determined whether a set of one or more criteria are satisfied for removal of an existing named batch. If so, processing branches to block 940; otherwise, processing continues with decision block 950. For example, based on metrics (e.g., batch counters and corresponding timestamps) maintained within historical usage information (e.g., historical usage data store 624), when the batch is observed within the command stream at a frequency lower than a frequency threshold, the existing named batch may be confirmed as a candidate for retirement.

At block 940, the existing named batch may be removed from the active profile. For example, the monitor module may issue a remove batch request to the batch manager, which may, in turn, transmit the request to the server platform.

At decision block 950, it is determined whether sufficient historical usage information for the transactional API is available to identify distinct usage patterns. If so processing continues with block 960; otherwise, the current iteration of adaptive optimization processing is complete.

At block 960, information regarding distinct usage patterns is identified and stored based on the available historical usage information (e.g., historical usage data store 624). For example, heuristic and/or machine-learning techniques may be used to analyze the historical usage information to identify such patterns and times at which the usage patterns change.

At decision block 970, a determination may be made regarding whether an imminent usage pattern change is expected. If so, processing continues with block 980; otherwise, the current iteration of adaptive optimization processing is complete. For example, this determination may be made by comparing the current time with a start time associated with the usage patterns identified at block 960.

At block 980, responsive to an imminent usage pattern change, a profile swap may be performed. For example, current state information (e.g., criteria data store 622, historical usage data store 624, and/or batch map 633) may be saved to the active profile and the current state information may be replaced with corresponding data stores from a different profile corresponding to the next usage pattern.

Wile in the context of the present example, usage patterns are described as being time-based (e.g., triggered by specific time events), it is to be appreciated usage patterns may be based on other triggers. For example, a usage pattern change may occur on one or more given days of the week (e.g., the start and/or end of the work week), on one or more given days of the month (e.g., the start and/or end of a given month, the start and mid-point of the given month, or the mid-point and the end of the given month), on holidays, on weekends, or at other intervals.

While in the context of the present example, all of blocks 910-980 are shown as being performed together, it is to be appreciated one or more portions (e.g., the evaluation regarding whether to remove or retire an existing named batch and the removal or retirement of the existing named batch (“Named Batch Retirement”) and/or the identification of an imminent usage pattern change and swapping of profiles (“Profile Swap”)) may be performed separately and independently of the evaluation regarding whether to create a new named batch and the creation of the new named batch (“New Named Batch Creation”). For example, the Named Batch Retirement may be performed by a separate task or thread from that of the New Named Batch Creation and/or the Profile Swap to allow the Named Batch Retirement to be performed responsive to a different trigger event or at a different cadence than the New Named Batch Creation and/or the Profile Swap. Similarly, the Profile Swap may be performed by a separate task or thread from that of the New Named Batch Creation and/or the Named Batch Retirement to allow the Profile Swap to be performed responsive to a different trigger event or at a different cadence than the New Named Batch Creation and/or the Named Batch Retirement.

### Example Service Scheduling Involving Named Batches

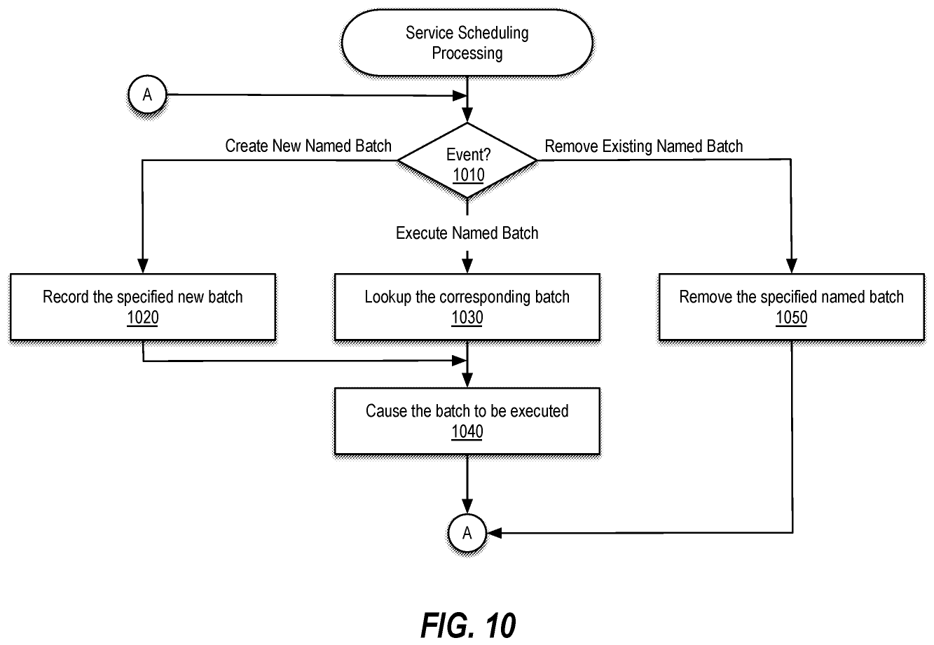

FIG. 10 is a flow diagram illustrating additional operations for performing service scheduling according to some embodiments. An example of service scheduling (without usage of the concept of a named batch) has previously been described with reference to FIG. 5 For sake of brevity, those operations previously described are not repeated here. Instead, it is suggested that FIG. 10 be read as supplementing those operations previously described. In one embodiment, service scheduling is performed by a service scheduler (e.g., service scheduler 632) after an event is received that is indicative of receipt of a request (e.g., a request to create a new named batch, a request to execute an existing named batch, or a request to remove an existing named batch transmitted by a batch scheduler (e.g., batch scheduler 612) via an interconnect (e.g., interconnect 220) or an event that is indicative of completion of execution of a given function call by an executer (e.g., executer 631).

At decision block 1010, a determination is made regarding what the event represents. If the event represents a request to create a new named batch (e.g., CreateBatch(Name, Batch)), processing continues with block 1020. If the event represents a request to execute a named batch (e.g., BatchName(Name, arg1, arg2, . . . )), processing continues with block 1030. If the event represents a request to remove an existing named batch (e.g., RemoveBatch(Name)), processing continues with block 1050.

At block 1020, the specified new batch is recorded. For example, the name (e.g., name 635a) of the new batch may be added to a batch lookup table (e.g., batch map 633) associated with the active profile (e.g., profile 629a) and a list of function descriptors (e.g., list of FDs 636a) of the function calls associated with the new batch may also be added to the batch lookup table. In the context of the present example, it is assumed the request to create a new batch also includes the batch to be executed. As such, following block 1020, processing continues with block 1040.

At block 1040, the service scheduler causes the batch to be executed by the executer. According to one embodiment, execution of a batch may involve the “Batch Received” path of FIG. 5, including blocks 530, 540 and 550.

At block 1030, the batch of function descriptors corresponding to the specified symbolic name is looked up within the batch lookup table. Then, the list of function descriptors (e.g., list of FDs 636a) corresponding to the symbolic name (e.g., name 635a) are caused to be executed at block 1040.

At block 1050, the specified named batch is removed from the batch lookup table.

While in the context of the flow diagrams presented herein, a number of enumerated blocks are included, it is to be understood that the examples may include additional blocks before, after, and/or in between the enumerated blocks. Similarly, in some examples, one or more of the enumerated blocks may be omitted or performed in a different order.

### Example Computer System

FIG. 11 is an example of a computer system 1100 with which some embodiments may be utilized. Notably, components of computer system 1100 described herein are meant only to exemplify various possibilities. In no way should example computer system 1100 limit the scope of the present disclosure. In the context of the present example, computer system 1100 includes a bus 1102 or other communication mechanism for communicating information, and one or more processing resources 1104 coupled with bus 1102 for processing information. The processing resources may be, for example, a combination of one or more compute resources (e.g., a microcontroller, a microprocessor, a CPU, a CPU core, a GPU, a GPU core, an ASIC, an FPGA, or the like) or a system on a chip (SoC) integrated circuit. Referring back to FIGS. 2A and 6, depending upon the particular implementation, the application platform 210 or 610 may be analogous to computer system 1100 and the server platform 230 or 630 may be analogous to host 1124 or server 1130 or the application platform 210 or 610 may be analogous to a first compute resource of computer system 1100 and the server platform 230 or 630 may be analogous to a second compute resource of computer system 1100.

Computer system 1100 also includes a main memory 1106, such as a random-access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, e.g., a magnetic disk, optical disk or flash disk (made of flash memory chips), is provided and coupled to bus 1102 for storing information and instructions.

Computer system 1100 may be coupled via bus 1102 to a display 1112, e.g., a cathode ray tube (CRT), Liquid Crystal Display (LCD), Organic Light-Emitting Diode Display (OLED), Digital Light Processing Display (DLP) or the like, for displaying information to a computer user. An input device 1114, including alphanumeric and other keys, is coupled to bus 1102 for communicating information and command selections to processor 1104. Another type of user input device is cursor control 1116, such as a mouse, a trackball, a trackpad, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Removable storage media 1140 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 1100 may implement the techniques described herein using customized hard-wired logic, one or more ASICs or FPGAs, firmware or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 1110. Volatile media includes dynamic memory, such as main memory 1106. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid-state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes interface circuitry 1118 coupled to bus 1102. The interface circuitry 1118 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. As such, interface 1118 may couple the processing resource in communication with one or more discrete accelerators 1105 (e.g., one or more XPUs).

Interface 1118 may also provide a two-way data communication coupling to a network link 1120 that is connected to a local network 1122. For example, interface 1118 may be an integrated services digital network (ISDN) card, cable modem, satellite modem, or a modem to provide a data communication connection to a corresponding type of telephone line. As another example, interface 1118 may be a local area network (LAN) card to provide a data communication connection to a compatible LAN. Wireless links may also be implemented. In any such implementation, interface 1118 may send and receive electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the worldwide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118. The received code may be executed by processor 1104 as it is received, or stored in storage device 1110, or other non-volatile storage for later execution.

While many of the methods may be described herein in a basic form, it is to be noted that processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that includes a non-transitory machine-readable medium storing instructions, which when executed by a processing resource of a computer system cause the processing resource to: monitor a command stream that includes function calls to be carried out by an executer related to an application, wherein the function calls are associated with a transactional application programming interface (API); and reduce an amount of data transmitted over an interconnect between the application and the executer by: identifying plurality of the function calls that represents a batch and satisfies a set of one or more criteria; creating a template of the batch having a symbolic name and including placeholders for at least a subset of variable arguments of the plurality of function calls; and transmitting via the interconnect the symbolic name and values for the subset of variable arguments.

Example 2 includes the subject matter of Example 1, wherein the values comprise immediate values or global memory references.

Example 3 includes the subject matter of any of Examples 1-2, wherein the set of one or more criteria includes a frequency threshold over a period of time.

Example 4 includes the subject matter of any of Examples 1-3, wherein the instructions further cause the processing resource to: evaluate historical usage of the transactional API; and after determining the batch no longer satisfies a criterion of the one or more criteria, remove the templatized version of the batch.

Example 5 includes the subject matter of any of Examples 1-4, wherein the instructions further case the processing resource to: track historical usage of the transactional API; and based on the historical usage, identify a plurality of distinct usage patterns associated with deterministic and predictable changes in use of the transactional API.

Example 6 includes the subject matter of Example 5, wherein the plurality of distinct usage patterns are associated with respective times of day.

Example 7 includes the subject matter of Example 5, wherein the instructions further cause the processing resource to: maintain a first profile for a first distinct usage pattern of the plurality of distinct usage patterns, the first profile including a first batch space including a plurality of templatized versions of batches created during the first distinct usage pattern; and maintain a second profile for a second distinct usage pattern of the plurality of distinct usage patterns, the second profile including a second batch space including a plurality of templatized versions of batches created during the second distinct usage pattern.

Example 8 includes the subject matter of Example 7, wherein the instructions further cause the processing resource to adapt to the deterministic and predictable changes in use of the transactional API by, during a transition from the first distinct usage pattern to the second distinct usage pattern: saving the first batch space to the first profile; and restoring the second batch space from the second profile.

Example 9 includes the subject matter of any of Examples 6-7, wherein the set of one or more criteria is part of the first profile or the second profile.

Some embodiments pertain to Example 10 that includes a method comprising: monitoring a command stream that includes function calls to be carried out by an executer related to an application, wherein the function calls are associated with a transactional application programming interface (API); and reducing an amount of data transmitted over an interconnect between the application and the executer by: after identifying a sequence of a plurality of the function calls that represents a batch and satisfies a set of one or more criteria, creating a templatized version of the batch having a symbolic name and including placeholders for a subset of variable arguments of the plurality of function calls; and after observing a subsequent occurrence of the sequence within the command stream, transmitting via the interconnect the symbolic name and values for the subset of variable arguments.

Example 11 includes the subject matter of Example 10, wherein the values comprise immediate values or global memory references.

Example 12 includes the subject matter of any of Examples 10-11, wherein the set of one or more criteria includes a frequency threshold over a period of time.

Example 13 includes the subject matter of any of Examples 10-12, further comprising: evaluating historical usage of the transactional API; and after determining the batch no longer satisfies a criterion of the one or more criteria, removing the templatized version of the batch.

Example 14 includes the subject matter of any of Examples 10-13, further comprising: tracking historical usage of the transactional API; and based on the historical usage, identifying a plurality of distinct usage patterns associated with deterministic and predictable changes in use of the transactional API.

Example 15 includes the subject matter of Example 14, wherein the plurality of distinct usage patterns are associated with respective times of day.

Example 16 includes the subject matter of Example 14, further comprising: maintaining a first profile for a first distinct usage pattern of the plurality of distinct usage patterns, the first profile including a first batch space including a plurality of templatized versions of batches created during the first distinct usage pattern; and maintaining a second profile for a second distinct usage pattern of the plurality of distinct usage patterns, the second profile including a second batch space including a plurality of templatized versions of batches created during the second distinct usage pattern.

Example 17 includes the subject matter of Example 16, further comprising adapting to the deterministic and predictable changes in use of the transactional API by, during a transition from the first distinct usage pattern to the second distinct usage pattern: saving the first batch space to the first profile; and restoring the second batch space from the second profile.

Example 18 includes the subject matter of any of Examples 16-17, wherein the set of one or more criteria is part of the first profile or the second profile.

Some embodiments pertain to Example 19 that includes a system comprising: a first processing resource; and instructions, which when executed by the first processing resource cause the first processing resource to: monitor a command stream that includes function calls to be carried out by a compute service or a second processing resource remote from the first processing resource related to an application, wherein the function calls are associated with a transactional application programming interface (API); and reduce an amount of data transmitted over an interconnect between the application and the compute service or the second processing resource by: after identifying a sequence of a plurality of the function calls that represents a batch and satisfies a set of one or more criteria, create a templatized version of the batch having a symbolic name and including placeholders for a subset of variable arguments of the plurality of function calls; and after observing a subsequent occurrence of the sequence within the command stream, transmit via the interconnect the symbolic name and values for the subset of variable arguments.

Example 20 includes the subject matter of Example 19, wherein the first processing resource comprises a central processing unit (CPU), a graphics processing unit (GPU), an application-specific integrated circuit (ASIC), or a field-programmable gate array (FPGA) of a first computer system.

Example 21 includes the subject matter of Example 20, wherein the second processing resource comprises a CPU, a GPU, an ASIC, or an FPGA of a second computer system.

Example 22 includes the subject matter of Example 20, wherein the second processing resource comprises a second CPU, a second GPU, a second ASIC, or a second FPGA of the first computer system.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A non-transitory machine-readable medium storing instructions, which when executed by a processing resource of a computer system cause the processing resource to:
monitor a command stream that includes function calls to be carried out by an executer related to an application, wherein the function calls are associated with a transactional application programming interface (API); and
reduce an amount of data transmitted over an interconnect between the application and the executer by:
identifying plurality of the function calls that represents a batch and satisfies a set of one or more criteria;
creating a template of the batch having a symbolic name and including placeholders for at least a subset of variable arguments of the plurality of function calls; and
transmitting via the interconnect the symbolic name and values for the subset of variable arguments.

2. The non-transitory machine-readable medium of claim 1, wherein the values comprise immediate values or global memory references.

3. The non-transitory machine-readable medium of claim 1, wherein the set of one or more criteria includes a frequency threshold over a period of time.

4. The non-transitory machine-readable medium of claim 1, wherein the instructions further cause the processing resource to:
evaluate historical usage of the transactional API; and
after determining the batch no longer satisfies a criterion of the one or more criteria, remove the templatized version of the batch.

5. The non-transitory machine-readable medium of claim 1, wherein the instructions further case the processing resource to:
track historical usage of the transactional API; and
based on the historical usage, identify a plurality of distinct usage patterns associated with deterministic and predictable changes in use of the transactional API.

6. The non-transitory machine-readable medium of claim 5, wherein the plurality of distinct usage patterns are associated with respective times of day.

7. The non-transitory machine-readable medium of claim 5, wherein the instructions further cause the processing resource to:
maintain a first profile for a first distinct usage pattern of the plurality of distinct usage patterns, the first profile including a first batch space including a plurality of templatized versions of batches created during the first distinct usage pattern; and
maintain a second profile for a second distinct usage pattern of the plurality of distinct usage patterns, the second profile including a second batch space including a plurality of templatized versions of batches created during the second distinct usage pattern.

8. The non-transitory machine-readable medium of claim 7, wherein the instructions further cause the processing resource to adapt to the deterministic and predictable changes in use of the transactional API by, during a transition from the first distinct usage pattern to the second distinct usage pattern:
saving the first batch space to the first profile; and
restoring the second batch space from the second profile.

9. The non-transitory machine-readable medium of claim 7, wherein the set of one or more criteria is part of the first profile or the second profile.

10. A method comprising:
monitoring a command stream that includes function calls to be carried out by an executer related to an application, wherein the function calls are associated with a transactional application programming interface (API); and
reducing an amount of data transmitted over an interconnect between the application and the executer by:
identifying a sequence of a plurality of the function calls that represents a batch and satisfies a set of one or more criteria;
creating a templatized version of the batch having a symbolic name and including placeholders for at least a subset of variable arguments of the plurality of function calls; and
after observing a subsequent occurrence of the sequence within the command stream, transmitting via the interconnect the symbolic name and values for the subset of variable arguments.

11. The method of claim 10, wherein the values comprise immediate values or global memory references.

12. The method of claim 10, wherein the set of one or more criteria includes a frequency threshold over a period of time.

13. The method of claim 10, further comprising:
evaluating historical usage of the transactional API; and
after determining the batch no longer satisfies a criterion of the one or more criteria, removing the templatized version of the batch.

14. The method of claim 10, further comprising:
tracking historical usage of the transactional API; and
based on the historical usage, identifying a plurality of distinct usage patterns associated with deterministic and predictable changes in use of the transactional API.

15. The method of claim 14, wherein the plurality of distinct usage patterns are associated with respective times of day.

16. The method of claim 14, further comprising:
maintaining a first profile for a first distinct usage pattern of the plurality of distinct usage patterns, the first profile including a first batch space including a plurality of templatized versions of batches created during the first distinct usage pattern; and
maintaining a second profile for a second distinct usage pattern of the plurality of distinct usage patterns, the second profile including a second batch space including a plurality of templatized versions of batches created during the second distinct usage pattern.

17. The method of claim 16, further comprising adapting to the deterministic and predictable changes in use of the transactional API by, during a transition from the first distinct usage pattern to the second distinct usage pattern:
saving the first batch space to the first profile; and
restoring the second batch space from the second profile.

18. The method of claim 16, wherein the set of one or more criteria is part of the first profile or the second profile.

19. A system comprising:
a first processing resource; and
instructions, which when executed by the first processing resource cause the first processing resource to:
monitor a command stream that includes function calls to be carried out by a compute service or a second processing resource remote from the first processing resource related to an application, wherein the function calls are associated with a transactional application programming interface (API); and
reduce an amount of data transmitted over an interconnect between the application and the compute service or the second processing resource by:
after identifying a sequence of a plurality of the function calls that represents a batch and satisfies a set of one or more criteria, creating a templatized version of the batch having a symbolic name and including placeholders for at least a subset of variable arguments of the plurality of function calls; and
after observing a subsequent occurrence of the sequence within the command stream, transmitting via the interconnect the symbolic name and values for the subset of variable arguments.

20. The system of claim 19, wherein the first processing resource comprises a central processing unit (CPU), a graphics processing unit (GPU), an application-specific integrated circuit (ASIC), or a field-programmable gate array (FPGA) of a first computer system.

21. The system of claim 20, wherein the second processing resource comprises a CPU, a GPU, an ASIC, or an FPGA of a second computer system.

22. The system of claim 20, wherein the second processing resource comprises a second CPU, a second GPU, a second ASIC, or a second FPGA of the first computer system.
